(19) United States
(12) Patent Application Publication
(10) Pub. No.: US 2026/0210715 A1
(43) Pub. Date: Jul. 23, 2026

(54) VIBRATION-TYPE ANGULAR VELOCITY SENSOR

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Keitaro ITO, Nisshin-shi (JP); Shota HARADA, Nisshin-shi (JP); Masaru NAGAO, Nisshin-shi (JP)

(21) Appl. No.: 19/407,076

(22) Filed: Dec. 3, 2025

(30) Foreign Application Priority Data
Jan. 20, 2025 (JP) 2025-007847

(51) Int. Cl. G01C 19/5726; G01C 19/5747

(52) U.S. Cl. CPC G01C 19/5726; G01C 19/5747

(57) ABSTRACT

A vibration-type angular velocity sensor includes a movable section having drive weights, detection weights for sensing externally applied angular velocity, and a drive beam connecting the drive and detection weights. The sensor further includes detection units to detect the displacements of the detection weights, a feedback unit that applies a restraining force to the detection weights to suppress their displacements, and a controller. The controller calculates values representing in-phase and anti-phase displacements of the detection weights based on output signals from the detection units. The in-phase displacement corresponds to both detection weights moving in the same direction, while anti-phase refers to opposite directions. The controller further determines a feedback amount such that the sum of the displacements in the in-phase state does not exceed a predetermined target value, and operates the feedback unit to apply the corresponding restraining force.

### CROSS REFERENCE TO RELATED APPLICATION

This application is based on Japanese Patent Application No. 2025-007847 filed on January 20, 2025, the disclosure of which is incorporated herein by reference.

### TECHNICAL FIELD

The present disclosure relates to a vibration-type angular velocity sensor.

### BACKGROUND

In a vibration-type angular velocity sensor, two inner drive weights, each provided with a detection weight, may be positioned side by side. Then, two outer drive weights may be placed on either side of these inner drive weights, effectively sandwiching them between the outer drive weights. These drive weights may be connected to drive beams.

### SUMMARY

According to an aspect of the present disclosure, a controller of a vibration-type angular velocity sensor may execute a calculation of an in-phase displacement based on output signals from the detection units. The in-phase displacement is displacement of the detection weights in an identical direction. In addition, the controller may execute a calculation of an anti-phase displacement based on the output signals from the detection units. The anti-phase displacement is displacement of the detection weights in opposite directions. Moreover, the controller may calculate a feedback amount, based on a result of the calculation of the in-phase displacement. The feedback amount corresponds to a restraining force suppressing sum of displacements of the detection weights in the in-phase displacement to be equal to or less than a predetermined target value. Furthermore, the controller may control a feedback unit to apply a restraining force based on the feedback amount.

### BRIEF DESCRIPTION OF DRAWINGS

FIG. 1 is a block diagram showing an outline of the vibration-type angular velocity sensor according to the first embodiment.

FIG. 2 is a top view showing the sensor unit of the vibration-type angular velocity sensor.

FIG. 3 is an explanatory diagram illustrating the basic operation of the sensor unit shown in FIG. 2.

FIG. 4 is an explanatory diagram illustrating the out-of-phase displacement of the detection weights when angular velocity is applied to the sensor unit shown in FIG. 2.

FIG. 5 is an explanatory diagram illustrating the in-phase displacement of the detection weights when acceleration is applied to the sensor unit shown in FIG. 2.

FIG. 6 is an explanatory diagram illustrating the outputs from the two detection units, the angular velocity output, and the zero-point bias error in each of the ideal state, the actual state, and the feedback state.

FIG. 7 is a block diagram showing an example configuration of the in-phase operation unit, the out-of-phase operation unit, the drive control unit, and the feedback control unit.

FIG. 8 is an explanatory diagram illustrating an example of signal processing between the sensor unit, the in-phase operation unit, the out-of-phase operation unit, and the feedback control unit.

FIG. 9 is a top view showing the sensor unit of the vibration-type angular velocity sensor according to the second embodiment.

FIG. 10 is an explanatory diagram illustrating an example of signal input from the sensor unit to the in-phase operation unit and out-of-phase operation unit in the second embodiment.

FIG. 11 is an explanatory diagram illustrating another example of signal processing between the sensor unit, the in-phase operation unit, the out-of-phase operation unit, and the feedback control unit in the second embodiment.

FIG. 12 is a block diagram showing an outline of the vibration-type angular velocity sensor according to the third embodiment.

FIG. 13 is a top view showing a modified example of the feedback unit in the second embodiment.

### DETAILED DESCRIPTION

A vibration-type angular velocity sensor may form a resonator in which four drive weights are connected by two drive beams arranged in parallel. When an angular velocity is applied from outside, the two detection weights may be displaced, and electrical signals corresponding to the amount of displacement of each may be output.

The above-mentioned vibration-type angular velocity sensor may have detection weights for detecting angular velocity, and when an angular velocity is applied, these detection weights may be displaced in opposite directions. As a result, the structure may reduce the influence received from external acceleration.

In this vibration-type angular velocity sensor, when acceleration from the outside is applied, the two detection weights may be displaced in the same direction. Therefore, if the displacement amounts of the two detection weights are the same, the influence of acceleration on angular velocity measurement may be canceled by taking the difference between the two electrical signals corresponding to each displacement amount. However, as a result of extensive studies by the inventors in the present application, it has been found that, in the above vibration-type angular velocity sensor, differences in the displacement amounts of the two detection weights may occur when acceleration is applied from outside, due to factors such as manufacturing errors, and this may cause fluctuations in the angular velocity output originating from the applied acceleration.

Hereinafter, the error in the angular velocity output signal caused by fluctuations arising from differences in the displacement amounts of the detection weights when acceleration is applied to the sensor will be referred to as “zero-point bias error.” As a method for reducing such zero-point bias error, for example, increasing the operating resonance frequency of the vibrator can be considered. However, increasing the resonance frequency may lead to a decrease in the measurement sensitivity of the angular velocity.

According to an aspect of the present disclosure, a vibration-type angular velocity sensor includes a movable section, detection units, a feedback unit, an in-phase calculation unit, an anti-phase calculation unit, and a feedback control unit. The movable section includes drive weights, detection weights and a drive beam. The detection weights detect externally applied angular velocity. The drive beam connects the drive weights to the detection weights. The detection units detect displacements of the detection weights. The feedback unit applies a restraining force to the detection weights to suppress the displacements. The in-phase calculation unit execute a calculation of an in-phase displacement based on respective output signals from the detection units. The in-phase displacement is displacement of the detection weights in an identical direction. The anti-phase calculation unit executes a calculation of an anti-phase displacement based on the respective output signals from the detection units. The anti-phase displacement is displacement of the detection weights in opposite directions. The feedback control unit calculates a feedback amount, based on a result of the calculation of the in-phase displacement. The feedback amount corresponds to the restraining force suppressing sum of the respective displacements of the detection weights in the in-phase displacement to be equal to or less than a predetermined target value. The feedback control unit controls the feedback unit to apply the restraining force based on the feedback amount.

As a result, the vibration-type angular velocity sensor is provided that includes detection weights, a feedback unit that applies a restraining force to the detection weights to suppress their displacement, and a feedback control unit that controls the restraining force based on the calculation result of the in-phase calculation unit for the in-phase displacement of the detection weights. The feedback control unit calculates a feedback amount so that the sum of the displacement amounts in the in-phase displacement of the detection weights is equal to or less than a predetermined target value, and executes control of the restraining force in accordance with the feedback amount. Accordingly, even when there is a difference in the displacement amounts of the detection weights due to manufacturing errors, the vibration-type angular velocity sensor can reduce zero-point bias error by suppressing the in-phase displacement of the weights when in-phase displacement is detected. In addition, since this vibration-type angular velocity sensor includes a feedback unit and a feedback control unit, it is not necessary to increase the operational resonance frequency of the vibrator in order to reduce zero-point bias error, and it is possible to suppress a decrease in angular velocity measurement sensitivity.

Hereinafter, embodiments of the present disclosure will be described with reference to the drawings. It should be noted that, in the following embodiments, identical or equivalent parts are denoted by the same reference numerals and will not be repeatedly described.

### First Embodiment

A vibration-type angular velocity sensor 1 according to the first embodiment will be described. The vibration-type angular velocity sensor 1 is a sensor that detects angular velocity as a physical quantity, that is, a gyro sensor. For example, The vibration-type angular velocity sensor 1 mounts on a vehicle and is used for in-vehicle applications to detect the angular velocity generated in the vehicle. However, the vibration-type angular velocity sensor 1 may also be applied to applications other than in-vehicle use.

### Overall Configuration

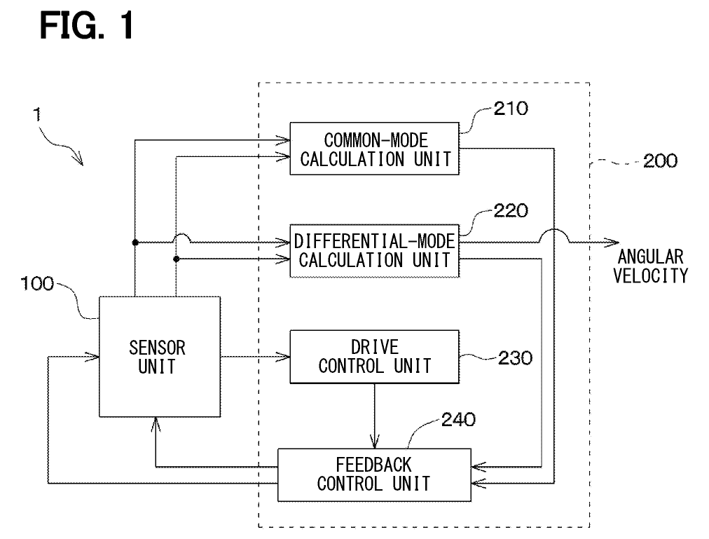

For example, as shown in FIG. 1, the vibration-type angular velocity sensor 1 according to the present embodiment includes a sensor unit 100 and a control unit 200 having an in-phase calculation unit 210, an anti-phase calculation unit 220, a drive control unit 230, and a feedback control unit 240. In the vibration-type angular velocity sensor 1, a signal from the sensor unit 100 is output to the in-phase calculation unit 210, the anti-phase calculation unit 220, and the drive control unit 230, respectively. The feedback control unit 240 executes feedback to the sensor unit 100 based on the calculation results from each unit.

The sensor unit 100 has, for example, an oscillator formed on a semiconductor substrate by a semiconductor process, and outputs a signal corresponding to the angular velocity when an external angular velocity is applied while the oscillator, which has mass portions, is in a vibrating state. The sensor unit 100, for example, has two detection weights, which are displaced when an angular velocity is applied, and two detection units, which detect the amount of displacement of the respective detection weights. The sensor unit outputs signals corresponding to the displacement of each detection weight. The sensor unit 100 includes a feedback unit, described later, for controlling the displacement of each detection weight, and, as necessary, the amount of displacement of each detection weight can be reduced under the control of the feedback control unit 240. Details of the sensor unit 100 will be described later.

The control unit 200 is configured, for example, as a microcomputer equipped with a CPU, RAM, ROM, and a non-volatile rewritable memory (all not shown), and also includes analog circuit components such as operational amplifiers and AD/DA converters. CPU, RAM, and ROM are abbreviations for Central Processing Unit, Random Access Memory, and Read Only Memory, respectively. In addition, AD and DA are abbreviations for Analog to Digital and Digital to Analog, respectively. The control unit 200 reads and executes a computer program stored in a ROM or non-volatile rewritable memory, which serves as a non-transitory tangible recording medium. When this computer program is executed, a method corresponding to the computer program is carried out. That is, the control unit 200 is provided with digital and analog circuits for exchanging signals with the sensor unit 100, and, in accordance with the aforementioned computer program, executes various control processes such as resonance vibration of the oscillator and reduction of the displacement of the detection weight. The control unit 200 may also be referred to as a controller in the present disclosure.

The in-phase calculation unit 210 treats a state in which detection weights in the sensor unit 100 are displaced in the same direction as “in-phase displacement,” and calculates the amount of displacement of each detection weight during in-phase displacement based on a signal obtained by adding or subtracting signals from the detection units in the sensor unit 100. In-phase displacement mainly occurs when acceleration is applied to the sensor unit 100 due to an external impact or the like. The calculation result of the in-phase calculation unit 210 is output to the feedback control unit 240 and is used for control to reduce the displacement amounts of the plurality of detection weights during in-phase displacement to a predetermined value or less. The configuration of the in-phase calculation unit 210 and details of the in-phase displacement will be described later.

The anti-phase calculation unit 220 treats a state in which detection weights in the sensor unit 100 are displaced in opposite directions as “anti-phase displacement,” and calculates the amount of displacement of each detection weight during anti-phase displacement based on a signal obtained by adding or subtracting signals from the detection units in the sensor unit 100. Anti-phase displacement mainly occurs when angular velocity is applied to the sensor unit 100 from the outside. The calculation result of the anti-phase calculation unit 220 is output to the feedback control unit 240 and is used for control to reduce the displacement of the detection weights caused by the applied angular velocity. In addition, the anti-phase calculation unit 220 calculates the angular velocity applied to the sensor unit 100 and outputs the calculated angular velocity information to the outside. The configuration of the anti-phase calculation unit 220 and details of the anti-phase displacement will be described later.

The drive control unit 230, based on signals from the sensor unit 100, detects the amplitudes of drive weights (to be described later) included in the sensor unit 100, and, while causing the drive weights to resonate, performs calculations and signal output to maintain the amplitude of the resonant vibration at a constant value. The calculation results of the drive control unit 230 are output to the feedback control unit 240 and are used to control the resonant vibration and amplitude of the drive weights. The configuration of the drive control unit 230 will be described later.

The feedback control unit 240, based on the calculation results from the in-phase calculation unit 210, the anti-phase calculation unit 220, and the drive control unit 230, executes control of feedback for applying either driving or restraining forces to the drive weights and detection weights of the sensor unit 100. The feedback control unit 240 outputs signals to a drive circuit that drives the sensor unit 100, and performs control to maintain the resonant vibration of the drive weights and reduce displacement of the detection weights. The configuration of the feedback control unit 240 will be described later.

### Configuration of the Sensor Unit

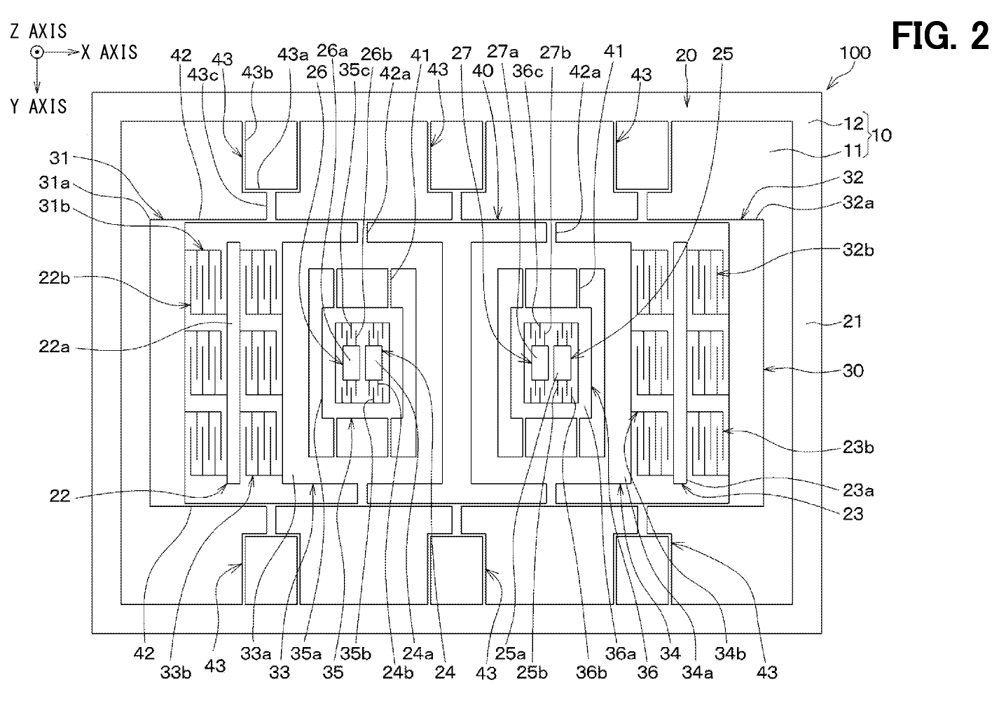

The sensor unit 100 is formed, for example, on one surface of a plate-shaped substrate 10 as shown in, for example, FIG. 2. The substrate 10 includes an SOI substrate having a structure in which a buried oxide film (not shown), serving as a sacrificial layer, is sandwiched between a support substrate 11 and a semiconductor layer 12. SOI stands for Silicon on Insulator. This sensor structure is configured by etching the semiconductor layer 12 side into the pattern of the sensor structure, then partially removing the buried oxide film, and releasing a portion of the sensor structure to create a floating state.

Hereinafter, for convenience of explanation and as shown in FIG. 2, the direction parallel to the surface of the semiconductor layer 12 and along the left-right direction of the drawing page of FIG. 2 is referred to as the “X-axis direction,” the direction perpendicular to the X-axis direction and along the up-down direction of the drawing page of FIG. 2 is referred to as the “Y-axis direction,” and the direction perpendicular to the surface of the semiconductor layer 12 is referred to as the “Z-axis direction.” The sensor unit 100 is adapted, for example, to automotive applications, such that the Z-axis direction—that is, the thickness direction of the substrate 10—coincides with the vertical direction of the vehicle.

The semiconductor layer 12 has a patterned shape including a fixed section 20, a movable section 30, and a beam section 40. The fixed section 20 has at least a part of its back surface with the buried oxide film remaining, and is fixed to the support substrate 11 via the buried oxide film without being released from the support substrate 11. The movable section 30 has the buried oxide film on the support substrate 11 side removed, and is in a hollow state released from the support substrate 11, allowing it to be displaced. The beam section 40 supports the movable section 30 and displaces the movable section 30 in the X-axis and Y-axis directions in order to detect angular velocity. The movable section 30 and the beam section 40 constitute the vibrator in the sensor unit 100.

The fixed section 20 includes a support portion 21 for supporting the movable section 30, drive portions 22 and 23 for driving the drive weights, detection units 24 and 25 used for angular velocity detection, and feedback units 26 and 27 for controlling the amount of displacement of detection weights 35 and 36, which will be described later.

The support portion 21 is formed, for example, as a frame shape that surrounds parts of the sensor structure such as the portions of the fixed section 20 other than the support portion 21 and the movable section 30, and supports the movable section 30 via the beam section 40 that is connected to its inner wall. It should be noted that the support portion 21 may have any shape as long as it is capable of supporting the movable section 30, and is not limited to a frame shape.

The drive portion 22 is a fixed portion disposed between an outer drive weight 31 and an inner drive weight 33, which will be described later. The drive portion 23 is a fixed portion disposed between an outer drive weight 32 and an inner drive weight 34, which will be described later. The drive portions 22 and 23 are configured, for example, to include base portions 22a and 23a extending in the Y-axis direction, and comb-shaped fixed drive electrodes 22b and 23b connected to the base portions 22a and 23a.

The base portions 22a and 23a, for example, have electrode pads (not shown), to which bonding wires (not shown) are connected, allowing a desired AC voltage for driving to be applied externally to the fixed drive electrodes 22b and 23b.

The fixed drive electrodes 22b and 23b are comb-shaped electrodes that are disposed facing the comb teeth of the comb-shaped movable drive electrodes 31b, 32b, 33b, and 34b, which are provided on the outer drive weights 31 and 32 and the inner drive weights 33 and 34, as will be described later. Specifically, the fixed drive electrodes 22b and 23b are composed of support sections extending in the X-axis direction and comb-shaped electrodes extending from each support section in the Y-axis direction. The fixed drive electrodes 22b and 23b are arranged in plural along the Y-axis direction on the surfaces of the base portions 22a and 23a that face the adjacent outer drive weights 31 and 32 or the inner drive weights 33 and 34.

The detection units 24 and 25 are arranged within regions surrounded by the detection weights 35 and 36, which will be described later, provided on the inner drive weights 33 and 34. The detection units 24 and 25 are each configured with a base portion 24a, 25a and fixed detection electrodes 24b, 25b.

The base portions 24a and 25a, for example, have electrode pads (not shown), to which bonding wires (also not shown) are connected, thereby enabling signal output to the outside. The fixed detection electrodes 24b and 25b are a plurality of comb-shaped electrodes extending in the Y-axis direction from the base portions 24a and 25a, and are disposed to face the respective comb teeth of the comb-shaped movable detection electrodes 35b and 36b provided on the detection weights 35 and 36.

The feedback units 26 and 27, together with the detection units 24 and 25, are disposed within regions surrounded by the detection weights 35 and 36. The feedback units 26 and 27 are each configured with a base portion 26a, 27a and fixed feedback electrodes 26b, 27b. The feedback units 26 and 27 are arranged separately from the detection units 24 and 25, and are electrically independent from the detection units 24 and 25.

The base portions 26a and 27a, for example, are provided with electrode pads (not shown), to which bonding wires (not shown) are connected, making it possible to apply a voltage to the fixed feedback electrodes 26b and 27b connected to the base portions 26a and 27a. The fixed feedback electrodes 26b and 27b are a plurality of comb-shaped electrodes extending from the base portions 26a and 27a in the Y-axis direction, and are arranged to face the respective comb teeth of comb-shaped movable feedback electrodes 35c and 36c provided on the detection weights 35 and 36. The fixed feedback electrodes 26b and 27b apply a restraining force to the detection weights 35 and 36 to limit their amount of displacement to a predetermined value or less when the detection weights 35 and 36 undergo in-phase displacement. Details regarding the control of in-phase displacement will be described later.

The movable section 30 is the section that displaces in response to the application of angular velocity. The movable section 30 is configured to include mass portions, namely, the outer drive weights 31 and 32, the inner drive weights 33 and 34, and the detection weights 35 and 36. The movable section 30 is configured such that the outer drive weight 31, the inner drive weight 33 housing the detection weight 35, the inner drive weight 34 housing the detection weight 36, and the outer drive weight 32 are arranged in this order along the X-axis direction. Hereinafter, the outer drive weights 31 and 32, the inner drive weights 33 and 34, and the detection weights 35 and 36 are collectively referred to as “mass portions 31–36,” and the outer drive weights 31 and 32 together with the inner drive weights 33 and 34 are collectively referred to as “drive weights 31–34.”

The outer drive weights 31 and 32 each have a mass portions 31a and 32a extending in the Y-axis direction, and movable drive electrodes 31b and 32b. The mass portion 31a is disposed facing the base portion 22a of the drive portion 22. The mass portion 32a is disposed facing the base portion 23a of the drive portion 23. The outer drive weights 31 and 32 are movable in the Y-axis direction, with the mass portions 31a and 32a serving as weights.

The movable drive electrodes 31b and 32b are comb-shaped electrodes provided on the mass portions 31a and 32a, and are arranged facing the respective comb teeth of the comb-shaped fixed drive electrodes 22b and 23b. Specifically, the movable drive electrodes 31b and 32b include support sections extending in the X-axis direction and comb-shaped electrodes extending in the Y-axis direction from each support section. The movable drive electrodes 31b and 32b are arranged in plural in the Y-axis direction on the surfaces of the mass portions 31a and 32a that face the drive portions 22 and 23, respectively.

The inner drive weights 33 and 34 each have mass portion 33a or 34a in the form of a rectangular frame, and movable drive electrodes 33b, 34b. The inner drive weights 33 and 34 are capable of moving in the Y-axis direction, with the mass portions 33a and 34a serving as the weights.

The mass portions 33a and 34a each have two sides parallel to the X-axis direction and two sides parallel to the Y-axis direction, with these sides connected to form a frame shape. Of the mass portion 33a, the side extending along the Y-axis direction faces the drive portion 22 and is provided with the movable drive electrode 33b. Of the mass portion 34a, the side extending along the Y-axis direction faces the drive portion 23 and is provided with the movable drive electrode 34b.

The detection weights 35 and 36 each have a configuration including a quadrilateral frame-shaped mass portion 35a or 36a, a movable detection electrode 35b or 36b, and a movable feedback electrode 35c or 36c. The mass portions 35a and 36a are disposed within the region surrounded by the mass portions 33a and 34a, and are supported on the inner wall surfaces of the inner drive weights 33 and 34 via detection beams 41, which are among the beam sections 40 and will be described later. The detection weights 35 and 36 are moved in the Y-axis direction together with the inner drive weights 33 and 34. In addition, the detection weights 35 and 36 are configured such that the mass portions 35a and 36a serve as weights, allowing the detection weights 35 and 36 to move in the X-axis direction.

The movable detection electrodes 35b and 36b are comb-shaped electrodes extending in the Y-axis direction from the inner wall surfaces of the mass portions 35a and 36a. The movable detection electrodes 35b and 36b are disposed to face the respective comb teeth of the fixed detection electrodes 24b and 25b.

The movable feedback electrodes 35c and 36c are comb-shaped electrodes extending in the Y-axis direction from the inner wall surfaces of the mass portions 35a and 36a, respectively. The movable feedback electrodes 35c and 36c are arranged to face the respective comb teeth of the fixed feedback electrodes 26b and 27b.

The beam section 40 includes a detection beam 41, a drive beam 42, and a support member 43. The detection beam 41 is a beam that connects the side of the inner wall surfaces of the mass portions 33a and 34a that is parallel to the X-axis direction to the side of the outer wall surfaces of the mass portions 35a and 36a that is parallel to the X-axis direction. The detection beam 41 is capable of displacement in the X-axis direction. The detection weights 35 and 36 are movable in the X-axis direction relative to the inner drive weights 33 and 34 based on the displacement of the detection beam 41.

The drive beam 42 connects the drive weights 31 to 34, and by flexing, enables the movement of the drive weights 31 to 34 in the Y-axis direction. The drive beam 42 connects the outer drive weight 31, the inner drive weight 33, the inner drive weight 34, and the outer drive weight 32 in this order, arranged sequentially. The drive beam 42 is a straight beam extending along the X-axis direction, with one beam disposed on each side of the drive weights 31 to 34 in the Y-axis direction. The two drive beams 42 are, for example, directly connected to the outer drive weights 31 and 32, and connected to the inner drive weights 33 and 34 via connecting portions 42a; however, it is also possible for all of the drive weights 31 to 34 to be directly connected.

The support member 43 is a member that supports the movable section 30. The support member 43 is provided between the inner wall surface of the support portion 21 and the drive beam 42, and supports the weights 31 to 36 included in the movable section 30 on the support portion 21 via the drive beam 42. The support member 43 includes a torsion beam 43a, a support beam 43b, and a connecting portion 43c.

The torsion beam 43a is a straight beam extending along the X-axis direction, with the support beams 43b connected to both ends in the direction of its extension. The connecting portion 43c is connected to the central position of the torsion beam 43a in its extending direction. The torsion beam 43a flexes in an S-shaped undulating manner around the connecting portion 43c as a center when the sensor is driven. The support beam 43b is a member that connects both ends of the torsion beam 43a to the support portion 21, and is, for example, a linear member. The support beam 43b also serves the role of allowing the weights 31 to 36 to move in the X-axis direction when subjected to impacts or the like. The connecting portion 43c connects the support member 43 to the drive beam 42.

The above describes the structure of the vibration-type angular velocity sensor 1. The vibration-type angular velocity sensor 1 has a pair of angular velocity detection structures formed by the movable section 30, which is provided with two outer drive weights, two inner drive weights, and two detection weights, respectively.

### Sensor Operation

Next, the operation of the sensor unit 100 will be described.

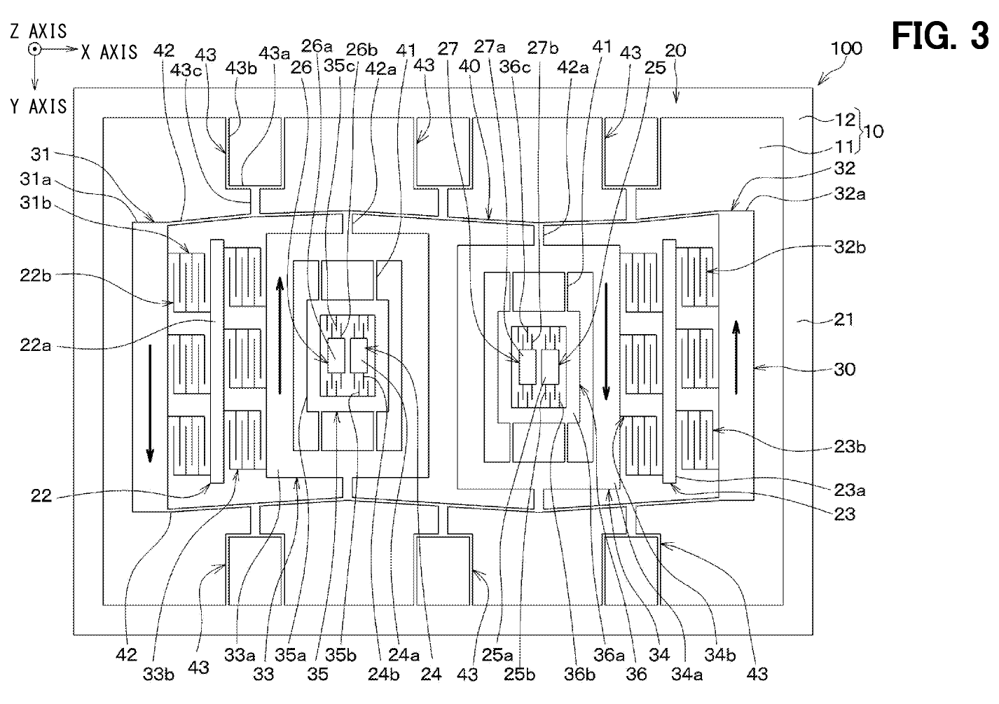

In the sensor unit 100, when a drive AC voltage, that is, a drive voltage, is applied to the drive portions 22 and 23 in response to a command from the control unit 200, a potential difference is generated between the drive portions and the drive weights 31 to 34, resulting in the generation of an electrostatic force in the Y-axis direction. In the sensor unit 100, due to the electrostatic force generated between the drive portions 22 and 23 and the drive weights 31 to 34, the drive weights 31 to 34 vibrate in the Y-axis direction, as shown in FIG. 3. Specifically, in the vibration-type angular velocity sensor 1, the outer drive weight 31 and the inner drive weight 33 are vibrated in mutually opposite directions along the Y-axis, and the outer drive weight 32 and the inner drive weight 34 are also vibrated in mutually opposite directions along the Y-axis. At this time, the sensor unit 100 is in a state in which the inner drive weights 33 and 34 are vibrated in mutually opposite phases along the Y-axis. Hereinafter, the above-described drive state shown in FIG. 3 may be referred to as the “drive mode.” The drive mode can be considered the basic operation of the sensor unit 100. The control unit 200 monitors the vibration of each of the drive weights 31 to 34 in the Y-axis direction while varying the frequency of the drive voltage, and adjusts the frequency so that it matches the drive resonance frequency.

In addition, in the above drive mode, the drive beam 42 undulates in an S-shape, allowing the drive weights 31 to 34 to move in the Y-axis direction, while the portions to which the connecting portions 43c are attached serve as nodes of vibration, that is, stationary points. The nodes of the drive beam 42 exhibit almost no displacement.

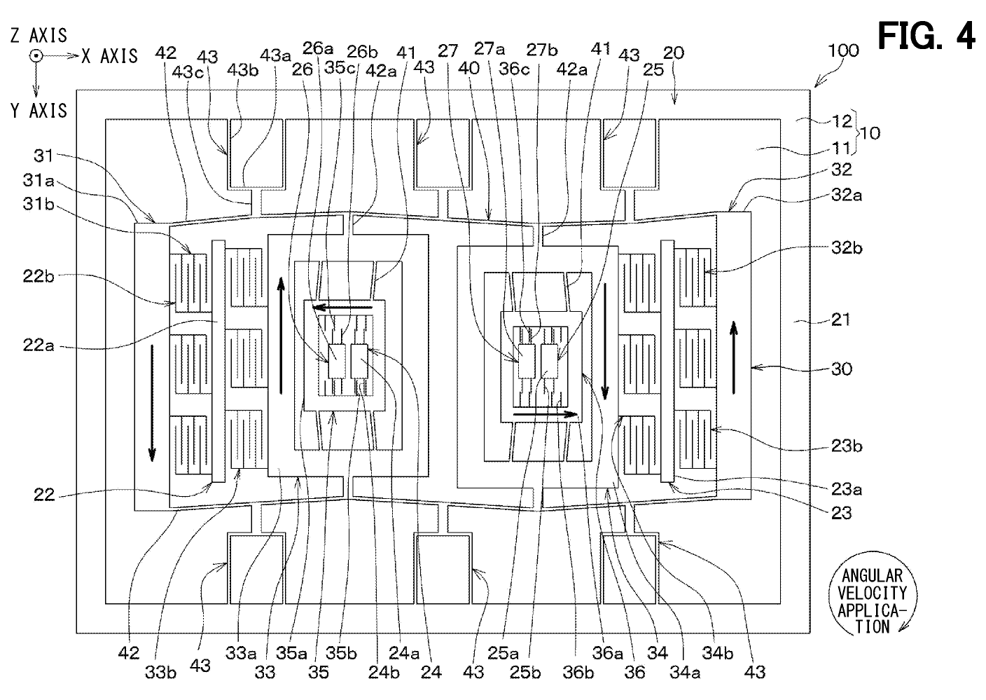

When an angular velocity around the Z-axis is applied to the sensor unit 100 in the drive mode, the Coriolis force causes, for example, the detection weights 35 and 36 to be displaced in the X-axis direction, as shown in FIG. 4. Due to this displacement, the capacitance value of the capacitor formed by the movable detection electrode 35b and the fixed detection electrode 24b, as well as the capacitance value of the capacitor formed by the movable detection electrode 36b and the fixed detection electrode 25b, changes. Then, the control unit 200 receives, for example via bonding wires (not shown) connected to the detection units 24 and 25, the changes in the capacitance values of the above capacitors as detection signals, and calculates the angular velocity applied to the sensor unit 100 based on the detection signals.

When an angular velocity due to an external Coriolis force is applied to the sensor unit 100, one of the detection weights 35 and 36 is displaced to the right in the X-axis direction and the other is displaced to the left in the X-axis direction, as shown in FIG. 4. In other words, when an angular velocity is applied, the two detection weights 35 and 36 are configured to undergo antiphase displacement, in which they are displaced in opposite directions to each other.

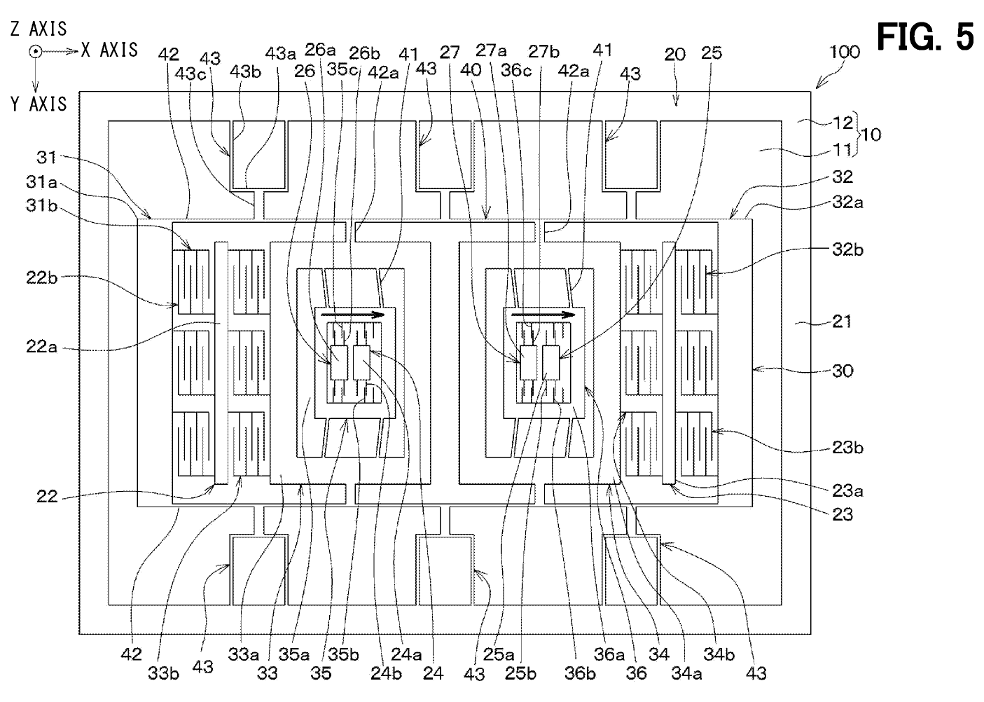

In addition, when an acceleration due to an external impact or the like is applied to the sensor unit 100, both detection weights 35 and 36 are displaced together either to the right or to the left in the X-axis direction, as shown in FIG. 5. In other words, when an acceleration is applied, the two detection weights 35 and 36 undergo in-phase displacement, in which both are displaced in the same direction.

### Zero-point Bias Error and Its Reduction

Next, the zero-point bias error in the sensor unit 100 and its reduction will be described.

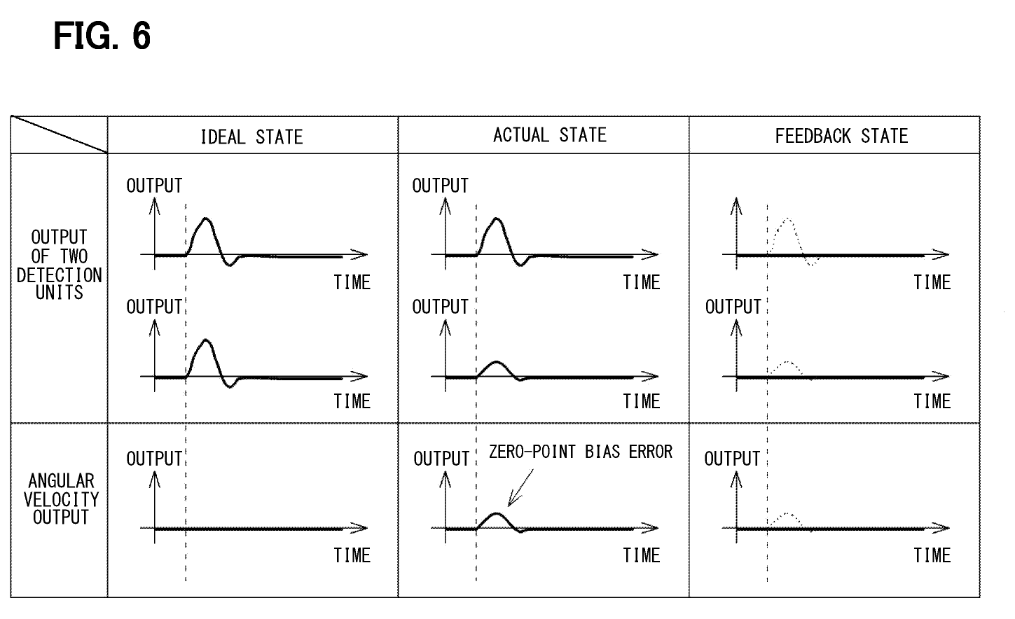

Assuming an “ideal state” in which the sensor unit 100 has no processing errors during the manufacturing process, when an acceleration is applied in this ideal state, the two detection weights 35 and 36 undergo in-phase displacement with identical amounts of displacement. At this time, the detection signals from detection units 24 and 25 exhibit waveforms with identical outputs at the same timing, as shown, for example, in the upper column of FIG. 6. Therefore, in the ideal state, the angular velocity output obtained by subtracting these two detection signals cancels out the output resulting from the applied acceleration. In other words, in the ideal state of the sensor unit 100, by taking the differential of the two detection signals, the angular velocity output caused by applied acceleration, i.e., the zero-point bias error, can be made zero.

However, in the actual sensor unit 100, unavoidable processing errors during the manufacturing process cause a difference in the amount of in-phase displacement that occurs in the two detection weights 35 and 36 when acceleration is applied. In this case, as shown in FIG. 6, the detection signals from detection units 24 and 25 differ in output due to the difference in the displacement amounts of detection weights 35 and 36. Therefore, in the actual state, the angular velocity output obtained by taking the differential of the detection signals from detection units 24 and 25 will contain residual output from the detection signals due to the in-phase displacement, as it is not completely canceled out. This residual angular velocity output, caused by applied acceleration and not canceled out, constitutes the zero-point bias error.

Accordingly, the control unit 200 performs feedback control that applies a restraining force to the detection weights 35 and 36 in the direction opposite to their displacement, so that the sum of the displacement amounts of the two detection weights 35 and 36 when an in-phase displacement occurs, as calculated by the in-phase calculation unit 210, is kept at or below a predetermined target value. In other words, the control unit 200 suppresses the displacement of the sum of the displacement amounts of the two detection weights 35 and 36 caused by in-phase displacement, that is, the influence due to applied acceleration, by executing feedback control. As a result, the displacement of the multiple weights due to applied acceleration is prevented from affecting the information on the displacement amounts of the two detection weights 35 and 36 when anti-phase displacement occurs, thereby improving the accuracy of angular velocity detection. The target value in the feedback control is preferably set to zero, but is not limited to this; it may also be a fixed value equal to or less than a predetermined value, or a value that varies periodically. For example, when an in-phase displacement is detected, the control unit 200 performs feedback control by applying a voltage to the feedback units 26 and 27 via the feedback control unit 240, thereby applying a force to the detection weights 35 and 36 to suppress the in-phase displacement. Hereinafter, for convenience of explanation, the state in which the above feedback control is executed may be referred to as the “feedback state.”

In the feedback state, the sensor unit 100 suppresses the in-phase displacement of the two detection weights 35 and 36 when acceleration is applied. Therefore, in the feedback state, the detection signals from the detection units 24 and 25 are such that, as shown for example in FIG. 6, the output prior to feedback control (indicated by the dashed line) is suppressed, and both outputs become equal to or less than a predetermined value, as indicated by the bold solid line. As a result, the angular velocity output obtained by taking the differential of the detection signals from the detection units 24 and 25 becomes equal to or less than a predetermined value for the angular velocity output caused by the applied acceleration (indicated by the dashed line), thereby reducing the zero-point bias error.

It should be noted that the feedback control unit 240 performs the above feedback control when in-phase displacement is detected. Therefore, the vibration-type angular velocity sensor 1 achieves reduced zero-point bias error and mainly outputs the calculation result of angular velocity based on the out-of-phase displacement of the two detection weights 35 and 36. It should be noted that FIG. 6 illustrates, as a representative example, the case where only acceleration is applied to the sensor unit 100 and no angular velocity is applied.

### Example Configuration of the Control Unit

Next, the in-phase calculation unit 210, the anti-phase calculation unit 220, the drive control unit 230, and the feedback control unit 240 will be described.

Hereinafter, the two detection signals output from the detection units 24 and 25 will be collectively referred to as “the two detection signals.”

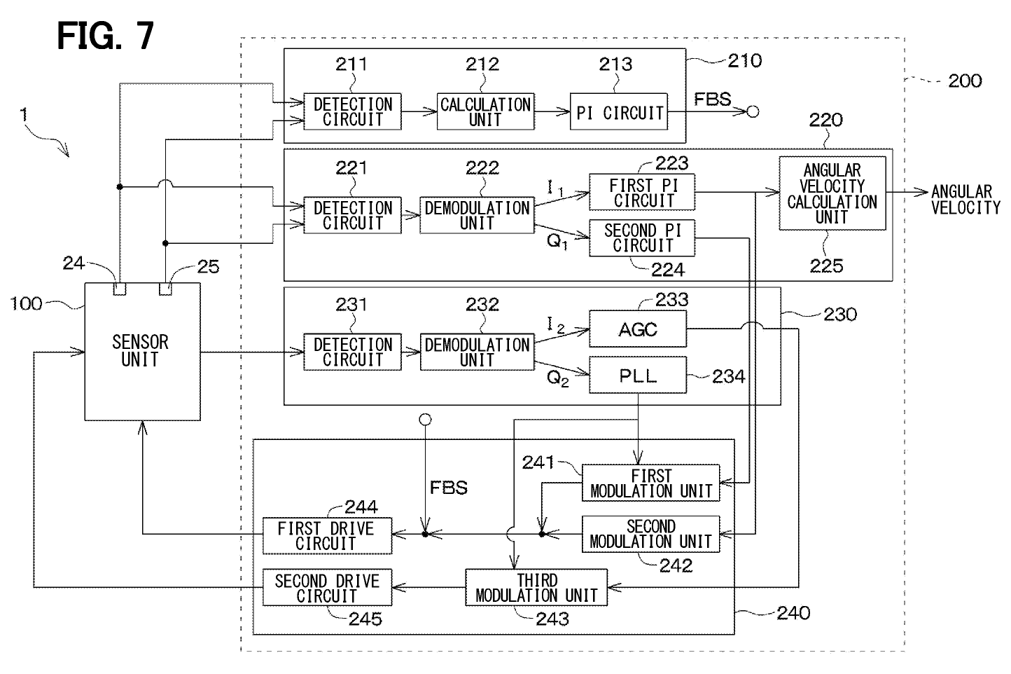

The in-phase calculation unit 210 is provided with, for example as shown in FIG. 7, a detection circuit 211, a calculation unit 212, and a PI circuit 213. PI stands for Proportional Integral. The in-phase calculation unit 210 detects the sum of the displacement amounts of the two detection weights 35 and 36, and outputs a feedback signal FBS corresponding to the sum of the displacement amounts of the two detection weights 35 and 36. It functions as a feedback calculation unit in feedback control.

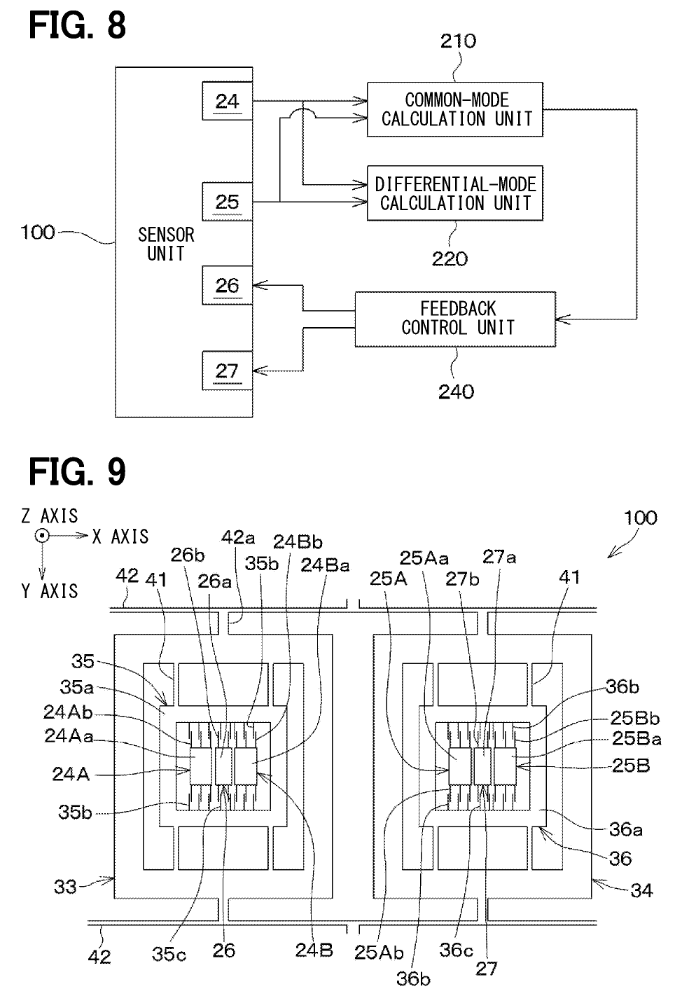

The detection circuit 211 detects the sum of the displacement amounts of the two detection weights 35 and 36 based on the two detection signals. In the case of in-phase displacement, the two detection weights 35 and 36 are displaced in the same direction. When displacement to one side in the X-axis direction is defined as positive and displacement to the other side as negative, the two detection units 24 and 25 output signals of the same polarity. The two detection signals are, for example, individually input to the in-phase calculation unit 210 as shown in FIG. 7 and FIG. 8, but they may also be summed before being input to the in-phase calculation unit 210. The same applies to the input to the anti-phase calculation unit 220. When the two detection signals are input individually, the detection circuit 211 performs an addition process on the two detection signals and outputs the result to the calculation unit 212.

The calculation unit 212, for example, calculates the absolute value of the difference between a preset target value and the amount of in-phase displacement detected by the detection circuit 211. The calculation unit 212 outputs the calculated absolute value to the PI circuit 213. This absolute value is used for feedback control to reduce the amount of in-phase displacement to the target value. When the absolute value calculated by the calculation unit 212 becomes nonzero, the control unit 200 executes negative feedback to cancel out the in-phase displacement of the detection weights 35 and 36.

The PI circuit 213 outputs a feedback signal FBS corresponding to the calculation result from the calculation unit 212. The feedback signal FBS is output to the first drive circuit 244, which will be described later, among the feedback control unit 240, and is used to generate a restraining force on the detection weights 35 and 36 to reduce the amount of in-phase displacement to a predetermined level or less. It should be noted that, in FIG. 7, part of the output path of the feedback signal FBS is omitted for clarity.

The anti-phase calculation unit 220, as shown for example in FIG. 7, includes a detection circuit 221, a demodulation unit 222, a first PI circuit 223, a second PI circuit 224, and an angular velocity calculation unit 225. The anti-phase calculation unit 220 detects the antiphase displacement of the detection weights 35 and 36, and also performs the calculation of the angular velocity caused by the Coriolis force generated in the sensor unit 100, thereby functioning as a calculation unit for the Coriolis force.

The detection circuit 221 detects the difference in displacement amounts between the two detection weights 35 and 36 based on the two detection signals. The detection circuit 221 is capable of detecting the amount of antiphase displacement by subtracting the two detection signals. When the two detection signals are individually provided, the detection circuit 221 performs a subtraction process on the two detection signals and outputs the result to the demodulation unit 222.

Based on the signal from the detection circuit 221, the demodulation unit 222 performs calculation of the in-phase demodulation output I₁ and the quadrature-phase demodulation output Q₁ for the detection weights 35 and 36, using the frequency signal of the sensor unit 100’s vibrator drive. The demodulation unit 222 outputs the demodulation output I₁ to the first PI circuit 223, and the demodulation output Q₁ to the second PI circuit 224, respectively.

The first PI circuit 223 corrects the demodulation output I₁ from the demodulation unit 222, and outputs the corrected signal to both the angular velocity calculation unit 225 and the second modulation unit 242 of the feedback control unit 240, which will be described later. The second PI circuit 224 corrects the demodulation output Q₁ from the demodulation unit 222, and outputs the corrected signal to the first modulation unit 241 of the feedback control unit 240, which will be described later.

The angular velocity calculation unit 225 calculates the angular velocity applied to the sensor unit 100 by dividing the output signal from the first PI circuit 223 by a pre-measured scale factor. The angular velocity calculation unit 225 outputs the calculated result of the angular velocity to an external circuit or the like (not shown).

The drive control unit 230 includes, for example as shown in FIG. 7, a detection circuit 231, a demodulation unit 232, an AGC 233, and a PLL 234. AGC stands for Automatic Gain Control, and is also referred to as automatic gain adjustment. PLL stands for Phase Locked Loop, and is also referred to as a phase synchronization loop. The drive control unit 230, for example, executes FtR control or force feedback control via a feedback control unit 240 that outputs drive signals to the drive portions 22 and 23 and the feedback units 26 and 27. FtR stands for Force to Rebalance, and is also referred to as forced rebalancing.

The detection circuit 231 detects the displacement of the drive weights 31 to 34 based on signals from the drive portions 22 and 23 of the sensor unit 100. The detection circuit 231 outputs a signal corresponding to the detected displacement of the drive weights 31 to 34 to the demodulation unit 232. The demodulation unit 232, based on the signal from the detection circuit 231, calculates the demodulated output I₂, which is in phase with the frequency signal of the resonant angular frequency in the drive mode of the oscillator of the sensor unit 100 for the drive weights 31 to 34, as well as the demodulated output Q₂, which is in quadrature phase. The demodulation unit 232 outputs the demodulated output I2 to the AGC 233 and the demodulated output Q₂ to the PLL 234, respectively.

The AGC 233 calculates the amplitude in the drive mode of the drive weights 31 to 34 based on the demodulated output I2, and also performs calculations and signal output to control the amplitude in the drive mode to a constant value. The AGC 233, for example, outputs a signal corresponding to the calculation result to the third modulation unit 243 of the feedback control unit 240.

The PLL 234 calculates the phase in the drive mode of the drive weights 31 to 34 based on the demodulated output Q₂, and also performs calculation and signal output of the drive signal for causing the drive weights 31 to 34 to undergo resonant vibration in the drive mode. The PLL 234 outputs signals corresponding to the calculation results to the first modulation unit 241 and the third modulation unit 243 of the feedback control unit 240, respectively.

The feedback control unit 240 includes a first modulation unit 241, a second modulation unit 242, a third modulation unit 243, a first drive circuit 244, and a second drive circuit 245. The first modulation unit 241 superimposes the output signal from the PLL 234 onto the output signal from the second PI circuit 224, and outputs the signal to the first drive circuit 244. The second modulation unit 242 modulates the output signal from the first PI circuit 223 and outputs the signal to the first drive circuit 244. The two output signals from the first modulation unit 241 and the second modulation unit 242 are added together as shown in FIG. 7, and then the feedback signal FBS from the in-phase calculation unit 210 is further added, after which the resultant signal is provided to the first drive circuit 244. The third modulation unit 243 superimposes the output signal from the PLL 234 onto the output signal from the AGC 233, and outputs the signal to the second drive circuit 245.

The first drive circuit 244 is a circuit that applies a voltage to the feedback units 26 and 27 in order to generate a restraining force to cancel out in-phase or antiphase displacement. The first drive circuit 244 receives a voltage signal based on the output signals from the modulation units 241 and 242 and the in-phase calculation unit 210, and applies a voltage to the feedback units 26 and 27 when displacement occurs in the detection weights 35 and 36. In other words, the first modulation unit 241, the second modulation unit 242, and the first drive circuit 244 are used to control negative feedback for canceling in-phase or antiphase displacement of the detection weights 35 and 36.

The second drive circuit 245 is a circuit that applies a drive voltage to the drive portions 22 and 23 in order to generate a driving force for causing the drive weights 31 to 34 to resonate. The second drive circuit 245 applies a drive voltage to the drive portions 22 and 23 to maintain the drive mode of the drive weights 31 to 34, based on the input signal from the third modulation unit 243. In other words, the third modulation unit 243 and the second drive circuit 245 are used to control drive feedback for maintaining the resonant vibration of the drive weights 31 to 34 at a constant level. Here, an example has been described in which the first drive circuit 244 and the second drive circuit 245 are configured as part of the feedback control unit 240. However, the present application is not limited to this example, and the drive circuits of the sensor unit 100 and the feedback control unit 240 may also be configured as separate units.

According to the present embodiment, the vibration-type angular velocity sensor 1 is provided, which includes: the detection weights 35 and 36; the feedback units 26 and 27 that generate a restraining force for suppressing displacement of the detection weights 35 and 36; and the feedback control unit 240 that controls the restraining force. The vibration-type angular velocity sensor 1 includes the in-phase calculation unit 210 that detects the in-phase displacement of the detection weights 35 and 36 and calculates the amount of in-phase displacement. The feedback control unit 240 calculates a feedback amount to keep the in-phase displacement amount at or below a predetermined target value, and performs control of the restraining force in accordance with the feedback amount. Therefore, even if there is a difference in the displacement amounts of the detection weights 35 and 36 due to manufacturing errors, the vibration-type angular velocity sensor 1 can detect the in-phase displacement and suppress the in-phase displacement to a predetermined value or less, thereby reducing zero-point bias error. In addition, since the vibration-type angular velocity sensor 1 includes the feedback units 26 and 27 and the feedback control unit 240, it is not necessary to increase the operational resonance frequency of the vibrator to reduce zero-point bias error, thereby making it possible to suppress a decrease in the measurement sensitivity of angular velocity.

The vibration-type angular velocity sensor 1 also has the following features: (1) In calculating the feedback amount to suppress the in-phase displacement, the feedback control unit 240 sets the target value to zero. As a result, the feedback control regulates the in-phase displacement amounts of the two detection weights 35 and 36 to zero, thereby making the zero-point bias error zero. (2) The in-phase calculation unit 210 calculates the in-phase displacement by processing that adds together the respective output signals from the detection units 24 and 25.

### Second Embodiment

The vibration-type angular velocity sensor 1 according to the second embodiment will be described.

The vibration-type angular velocity sensor 1 according to the present embodiment differs from the first embodiment described above in that, as shown in FIG. 9, the configuration of the detection units 24 and 25 and the detection weights 35 and 36 of the sensor unit 100 has been partially modified. In the present embodiment, the explanation will focus primarily on these differences. In FIG. 9, the detection units 24 and 25 and the detection weights 35 and 36, as well as their vicinity, are shown among the sensor unit 100. For the sake of clarity, the movable drive electrodes of the inner drive weights 33 and 34 are omitted.

In the present embodiment, the detection units 24 and 25 are each configured to include a first detection unit 24A or 25A and a second detection units 24B or 25B. The first detection units 24A and 25A are, for example, disposed on the left side in the X-axis direction away from the feedback units 26 and 27, and include mass portions 24Aa and 25Aa and fixed detection electrodes 24Ab and 25Ab, respectively. The fixed detection electrodes 24Ab and 25Ab are parallel-plate electrodes that are extended in plural along the Y-axis direction from the side of the mass portions 24Aa and 25Aa facing the detection weights 35 and 36, and are arranged in parallel along the X-axis direction. The fixed detection electrodes 24Ab and 25Ab are arranged to face the movable detection electrodes 35b and 36b of the detection weights 35 and 36, respectively, with their positions offset in the X-axis direction. In the present embodiment, the movable detection electrodes 35b and 36b are parallel-plate electrodes provided in plural along the Y-axis direction from the sides facing the detection units 24A, 24B, 25A, and 25B, and are arranged in parallel along the X-axis direction.

The second detection units 24B and 25B are, for example, disposed on the right side in the X-axis direction away from the feedback units 26 and 27, and include mass portions 24Ba and 25Ba, as well as fixed detection electrodes 24Bb and 25Bb. The fixed detection electrodes 24Bb and 25Bb are parallel-plate electrodes that are extended in plurality along the Y-axis direction from the sides of the mass portions 24Ba and 25Ba facing the detection weights 35 and 36, and are arranged in parallel along the X-axis direction. The fixed detection electrodes 24Bb and 25Bb are arranged to face the movable detection electrodes 35b and 36b with their positions offset in the X-axis direction. The second detection units 24B and 25B are arranged back-to-back with the first detection units 24A and 25A, on the opposite side of the feedback units 26 and 27. In this embodiment, the fixed feedback electrodes 26b and 27b, as well as the movable feedback electrodes 35c and 36c, are also parallel-plate type electrodes, similar to the electrodes 24Ab, 25Ab, 24Bb, and 25Bb.

The first detection units 24A and 25A and the second detection units 24B and 25B are configured such that, when the detection weights 35 and 36 move closer to one side, the capacitance of the capacitor increases, while for the other side, as the detection weights 35 and 36 move away, the capacitance of the capacitor decreases. Therefore, if the detection signal is defined as positive when the capacitance increases, and negative when it decreases, the first detection units 24A and 25A and the second detection units 24B and 25B are configured such that, upon displacement of the detection weights 35 and 36, one outputs a positive detection signal while the other outputs a negative detection signal. In other words, in this embodiment, the detection units 24 and 25 are configured to have two types of electrodes: electrodes that output detection signals of positive polarity, and electrodes that output detection signals of negative polarity when displacement of the detection weights 35 and 36 occurs. When the displacement of the detection weights 35 and 36 is small, the first detection units 24A and 25A and the second detection units 24B and 25B exhibit the same amount of change in capacitance.

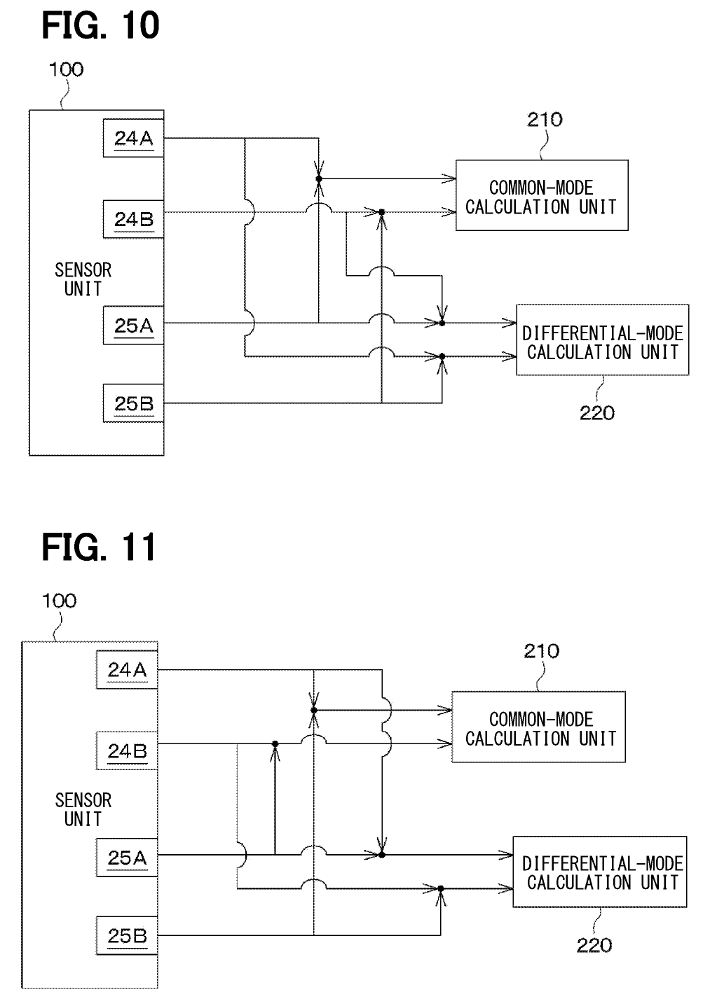

In this embodiment, for example as shown in FIG. 10, the in-phase calculation unit 210 receives a first addition signal, which is the sum of two output signals from the first detection units 24A and 25A, and a second addition signal, which is the sum of two output signals from the second detection units 24B and 25B. It should be noted that the in-phase calculation unit 210 may receive only one of the above-mentioned first or second addition signals as input.

For example, the anti-phase calculation unit 220 receives as input a third addition signal, which is the sum of two output signals from the first detection unit 24A and the second detection unit 25B, and a fourth addition signal, which is the sum of two output signals from the second detection unit 24B and the first detection unit 25A. The anti-phase calculation unit 220 may receive only one of the above-mentioned third or fourth addition signals as input.

It should be noted that the signals provided to the in-phase calculation unit 210 and the anti-phase calculation unit 220 may be differential signals obtained by taking the difference between the output signals from the two detection units, instead of the above-mentioned addition signals. For example, as shown in FIG. 11, the in-phase calculation unit 210 may receive as input at least one of a first differential signal between the two output signals from the first detection unit 24A and the second detection unit 25B, and a second differential signal between the two output signals from the second detection unit 24B and the first detection unit 25A. Also, for example, the anti-phase calculation unit 220 may receive as input at least one of a third differential signal between the two output signals from the first detection units 24A and 25A, and a fourth differential signal between the two output signals from the second detection units 24B and 25B.

With this embodiment as well, the vibration-type angular velocity sensor 1 can be obtained that achieves the same effects as the first embodiment described above. In addition, the detection units 24 and 25 are each including the first detection unit 24A or 25A and the second detection unit 24B or 25B, which output detection signals of opposite polarity (positive and negative) with respect to the displacement of the detection weights 35 and 36. Therefore, in the sensor unit 100, the influence of parasitic capacitance existing between the detection units 24 and 25 and the in-phase calculation unit 210 or the anti-phase calculation unit 220 is reduced. As a result, the vibration-type angular velocity sensor 1 has a structure in which the calculation accuracy of the in-phase displacement of the detection weights 35 and 36 is improved, thereby enhancing the accuracy of feedback control and further reducing the zero-point bias error.

In addition, the vibration-type angular velocity sensor 1 of this embodiment has the following features.

(1) The in-phase calculation unit 210 calculates the in-phase displacement by adding the output signals respectively from the first detection unit 24A or 25A and the second detection unit 24B or 25B.

(2) The in-phase calculation unit 210 calculates the in-phase displacement by differentially processing (subtracting) the output signals from the first detection unit 24A or 25A and the second detection unit 24B or 25B.

### Third Embodiment

The vibration-type angular velocity sensor 1 according to the third embodiment will be described.

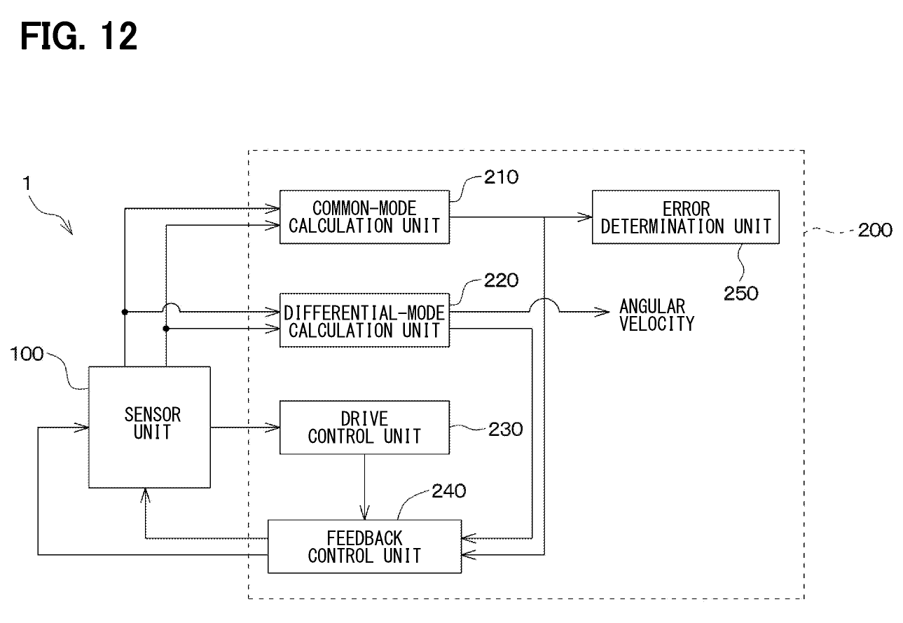

The vibration-type angular velocity sensor 1 of the present embodiment differs from the first embodiment in that, as shown for example in FIG. 12, the control unit 200 further includes an error determination unit 250. In the present embodiment, the explanation will mainly focus on this point of difference.

In the present embodiment, the control unit 200 is provided with an error determination unit 250. The error determination unit 250 receives the calculation result of the in-phase displacement from the in-phase calculation unit 210, and determines whether the value of the in-phase displacement is equal to or greater than a predetermined value. For example, the error determination unit 250 performs an error determination as to whether the amount of in-phase displacement is equal to or greater than a predetermined threshold value set in advance, based on the calculation result from the in-phase calculation unit 210. For example, the error determination unit 250 determines that an error has occurred when the amount of in-phase displacement is equal to or greater than the threshold value, and outputs this as an error signal. For example, when the error determination unit 250 determines that an error has occurred, the angular velocity calculated by the angular velocity calculation unit 225 is regarded as an abnormal value and is either not output externally or not used for other processing.

According to the present embodiment, the effects of the first embodiment can be obtained, and by providing the error determination unit 250, it is possible to prevent the calculated angular velocity from being used for other processing or the like when the in-phase displacement is equal to or greater than a predetermined magnitude, thereby providing a vibration-type angular velocity sensor 1.

### Other Embodiments

The present disclosure has been described in accordance with the embodiments, but it is to be understood that the present disclosure is not limited to these embodiments or structures. The present disclosure also encompasses various modifications and alterations within an equivalent scope. In addition, various combinations and forms, as well as other combinations or forms including only one of those elements, more, or fewer, are also within the scope and spirit of the present disclosure.

(1) In each of the embodiments described above, the sensor unit 100 has been explained, as a representative example, as having a structure that detects the displacement of the detection weights 35 and 36 based on changes in capacitance; however, the present disclosure is not limited thereto. For example, the method for detecting the displacement of the detection weights 35 and 36 may utilize the piezoresistive effect or the piezoelectric effect, or it may be based on an induced current generated by electromagnetic induction. Any method other than the capacitive type may also be adopted. In this way, it is only necessary for the detection units 24 and 25 to be capable of detecting the displacement of the detection weights 35 and 36, and their structure, arrangement, and the like may be appropriately modified according to the detection method employed.

(2) Further, the feedback units 26 and 27 may be configured to suppress the common-mode displacement of the detection weights 35 and 36 by means of a force other than electrostatic force. For example, the feedback units 26 and 27 may be constituted by piezoelectric films arranged on the detection beams 41, and the common-mode displacement of the detection weights 35 and 36 may be suppressed by driving the piezoelectric films. In this manner, the feedback units 26 and 27 only need to be capable of applying an external force to suppress displacement of the detection weights 35 and 36, and their structure, arrangement, and the like may be appropriately modified as necessary.

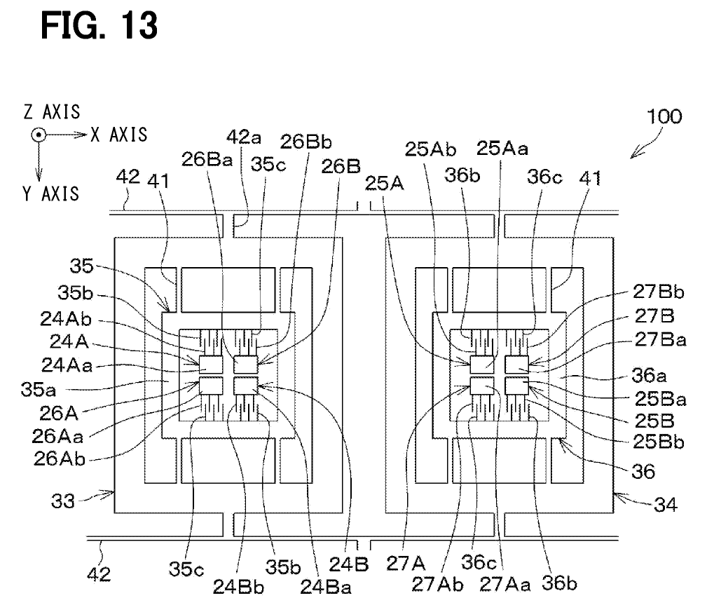

(3) In the above second embodiment, a structure was described in which one feedback unit 26 or 27 is arranged within the region surrounded by the detection weights 35 and 36, but the sensor unit 100 is not limited to this structure, and may also have a configuration in which two feedback units 26 or 27 are arranged. The feedback unit 26 include, for example, the first feedback unit 26A and the second feedback unit 26B, as shown in FIG. 13. For example, the first feedback unit 26A has the mass portion 26Aa and the parallel-plate type fixed feedback electrodes 26Ab, and the fixed feedback electrodes 26Ab are provided only on one side of the mass portion 26Aa that faces the detection weight 35 on the lower side in the Y-axis direction. The first feedback unit 26A is positioned on the left side in the X-axis direction and on the lower side in the Y-axis direction, and is disposed facing the first detection unit 24A, which is arranged on the upper side in the Y-axis direction. In this modification, the first detection unit 24A is provided with the fixed detection electrodes 24Ab only on the one side that faces the detection weight 35 on the upper side in the Y-axis direction.

The second feedback unit 26B has the mass portion 26Ba and the parallel-plate type fixed feedback electrodes 26Bb, and the fixed feedback electrodes 26Bb are provided only on the one side of the mass portion 26Ba that faces the detection weight 35 on the upper side in the Y-axis direction. The second feedback unit 26B is positioned on the right side in the X-axis direction and on the upper side in the Y-axis direction, and is disposed facing the second detection unit 24B, which is arranged on the lower side in the Y-axis direction. In this modification, the second detection unit 24B is provided with the fixed detection electrodes 24Bb only on the one side that faces the detection weight 35 on the lower side in the Y-axis direction.

The feedback unit 26 is configured such that, for example, when the detection weight 35 is displaced to the right and its displacement is to be suppressed, a positive voltage is applied to the first feedback unit 26A and a negative voltage is applied to the second feedback unit 26B. The feedback unit 27 includes the first feedback unit 27A and the second feedback unit 27B, and has the same configuration and arrangement as the feedback unit 26. The feedback units 27A and 27B each have the mass portion 26Aa or 27Aa and the parallel plate-type fixed feedback electrode 26Ab or 27Ab, and have the same configuration as the feedback units 26A and 26B. In addition, the detection unit 25 has the same configuration and arrangement as the detection unit 24. Also in this modified example, a vibration-type angular velocity sensor 1 is obtained that provides the same effects as those of the above-described second embodiment. As described above, in the vibration-type angular velocity sensor 1 of the second embodiment, the number, size, arrangement, and the like of the feedback units 26 and 27 in the sensor unit 100 may be appropriately changed.

(4) The control unit 200 and its method described in the present disclosure may be implemented by a dedicated computer provided by configuring a processor and memory that are programmed to execute one or more functions embodied by a computer program. Alternatively, the control unit 200 and its method described in the present disclosure may be implemented by a dedicated computer provided by configuring the processor using one or more dedicated hardware logic circuits. Alternatively, the control unit 200 and its method described in the present disclosure may be implemented by one or more dedicated computers, each configured by a combination of a processor and memory programmed to execute one or more functions and a processor configured by one or more hardware logic circuits. Furthermore, the computer program may be stored as instructions executable by a computer on a computer-readable non-transitory tangible recording medium.

(5) It goes without saying that, in each of the above embodiments, the elements constituting the embodiments are not necessarily essential unless they are expressly stated to be essential or are considered to be essential in principle. Furthermore, in each of the above embodiments, when the number, value, quantity, range, or other numerical values of the constituent elements of the embodiment are mentioned, they are not limited to those specific numbers unless it is expressly stated to be essential or it is clearly limited to a specific number in principle. Furthermore, in each of the above embodiments, when referring to the shapes, positional relationships, or the like of constituent elements, such shapes, positional relationships, and the like are not limited thereto unless it is expressly stated or it is clearly limited to a specific shape, positional relationship, or the like in principle.

What is claimed is:

1. A vibration-type angular velocity sensor comprising:
a movable section including
drive weights,
detection weights configured to detect externally applied angular velocity, and
a drive beam connecting the drive weights to the detection weights;
detection units configured to detect displacements of the detection weights;
a feedback unit configured to apply a restraining force to the detection weights to suppress the displacements; and
a controller including at least one of (i) a circuit and (ii) a processor with a memory storing computer program code executable by the processor, the at least one of the circuit and the processor configured to cause the controller to
execute a calculation of an in-phase displacement based on respective output signals from the detection units, the in-phase displacement being displacement of the detection weights in an identical direction,
execute a calculation of an anti-phase displacement based on the respective output signals from the detection units, the anti-phase displacement being a state in which the detection weights are displaced in opposite directions,
calculate a feedback amount, based on a result of the calculation of the in-phase displacement, the feedback amount corresponding to the restraining force suppressing sum of the displacements of the detection weights in the in-phase displacement to be equal to or less than a predetermined target value, and
control the feedback unit to apply the restraining force based on the feedback amount.

2. The vibration-type angular velocity sensor according to claim 1, wherein
the controller is configured to set the predetermined target value to zero when calculating the feedback amount.

3. The vibration-type angular velocity sensor according to claim 1, wherein
the controller is configured to execute the calculation of the in-phase displacement by summing the respective output signals from the detection units.

4. The vibration-type angular velocity sensor according to claim 1, wherein
the detection units belong to either of two kinds that are:
a first detection unit configured to output a signal of positive polarity in response to a displacement of one of the detection weights; and
a second detection unit configured to output a signal of negative polarity in response to the displacement of the one of the detection weights.

5. The vibration-type angular velocity sensor according to claim 4, wherein
the controller is configured to execute the calculation of the in-phase displacement, by performing summation on respective output signals from the first detection unit and the second detection unit.

6. The vibration-type angular velocity sensor according to claim 4, wherein
the controller is configured to execute the calculation of the in-phase displacement, by performing subtraction on respective output signals from the first detection unit and the second detection unit.

7. The vibration-type angular velocity sensor according to claim 1, wherein
the controller is configured to determine whether a value acquired by the calculation of the in-phase displacement is larger than or equal to a predetermined value.
